(19) United States
(12) Patent Application Publication
(10) Pub. No.: US 2024/0369677 A1
(43) Pub. Date: Nov. 7, 2024

(54) RADAR SYSTEM FOR A MOTOR VEHICLE

(71) Applicant: COMPAGNIE PLASTIC OMNIUM SE, LYON (FR)

(72) Inventors: Mathieu BANCELIN, Sainte-Julie (FR); Philippe GILOTTE, Sainte-Julie (FR); Laurent ROCHEBLAVE, Sainte-Julie (FR); Frédéric STABLO, Sainte-Julie (FR)

(73) Assignee: COMPAGNIE PLASTIC OMNIUM SE, LYON (FR)

(21) Appl. No.: 18/687,123

(22) PCT Filed: Sep. 2, 2022
(86) PCT No.: PCT/EP2022/074498

§ 371 Date: Feb. 27, 2024

(30) Foreign Application Priority Data
Sep. 3, 2021 (FR) FR2109249

(51) Int. Cl. G01S 7/03; G01S 13/00; G01S 13/931

(52) U.S. Cl. CPC G01S 7/03; G01S 13/003; G01S 13/931

(57) ABSTRACT

Radar system for a motor vehicle includes an electronic unit configured to transmit and receive an electromagnetic wave in a predetermined frequency range, a first directional antenna which is arranged on a first body part of the vehicle and has a first cavity reflecting electromagnetic waves, wherein a first metasurface is positioned, a second directional antenna which is arranged on a second body part and has a second cavity reflecting electromagnetic waves wherein a second metasurface is positioned, said second antenna being configured for connection to the electronic unit via a second waveguide and for transmitting an electromagnetic wave transmitted by the electronic unit and propagated via the second waveguide in a second predetermined direction and/or for propagating a received electromagnetic wave to the electronic unit via the second waveguide.

The present disclosure relates to the field of motor vehicles, for example automobiles, equipped with a radar system for transmitting and/or receiving an electromagnetic wave in a desired direction, in particular for detecting an obstacle.

Motor vehicles are known that are equipped with radar-type devices, generally positioned on the front and rear bumpers of the vehicle. These radar devices are used for parking assistance as well as for driving assistance, for example for adaptive cruise control (ACC) applications wherein the radar device detects the speed and the distance of a vehicle preceding the vehicle carrying the radar device. Such a radar is used in particular to regulate vehicle speed based on the traffic and/or obstacles on the road. The radar detects the speed and the distance of the object preceding the carrier vehicle, so as in particular to maintain a safety distance between the vehicles.

In general, a major area of application for radars in the motor vehicle industry is that of the vehicle body, wherein more and more radar modules are being integrated in order to allow total peripheral detection around the vehicle, for example for equipment such as parking assistance systems, reversing assistance systems or pedestrian protection installations, or other systems of this type. However, these various radars are of different types depending on their detection field (long or short distance, front detection or lateral detection, etc.) and their function (parking, autonomous driving, etc.), but also according to their manufacturer, which does not allow them to optimally consolidate the data provided by each one independently to the various equipment of the vehicle that can use them (braking, steering, headlights, sound or visual alarms, etc.).

Thus, in order to better characterize the peripheral environment of the vehicle, motor vehicle manufacturers need devices making it possible to improve, on the one hand, the size of the volume to be monitored around the vehicle, and on the other hand, the resolution of the processing of the information originating from these devices. This is intended to allow the vehicle to interact optimally, that is, with more precision and more quickly, with its environment, in particular to avoid accidents, facilitate maneuvers and drive autonomously.

In order to increase the peripheral detection by volume (3D) around the vehicle, automobile manufacturers are led to multiply the number of radars distributed over a given surface.

However, the increase in the number of radars used leads to an increase in the cost.

In addition, the increase in the number of radars requires a continuous supply of numerous radiofrequency tracks, which consumes considerable energy, which is very detrimental in particular for autonomous and/or electric vehicles.

Moreover, even if the radars can be miniaturized slightly, the increase in the number of radars distributed over a given surface may be difficult to achieve due to the limited available area (the size of the body parts cannot be increased) as well as the presence of other equipment, all the more so since it may be necessary to maintain a minimum distance between each radar in order to prevent them from interfering with one another.

In order to obtain additional information relative to the position and speed of an obstacle given by the radars, devices are sought which in particular have an increased spatial resolution making it possible for example to recognize the objects (environment or obstacles) surrounding the vehicle, to track their trajectory, to constitute the most comprehensive imaging thereof as possible.

Thus, vehicles are increasingly provided with complementary devices to radars, such as LIDAR and cameras.

The spatial resolution expresses the ability of an observation device to distinguish details. It can be characterized in particular by the minimum distance that must separate two contiguous points so that they are correctly discerned.

In the case of a radar, this resolution distance is based on the ratio between the wavelength of the wave used for the observation, and the size of the opening of the observation device. Thus, to improve the spatial resolution, that is, to decrease the resolution distance, it is necessary to reduce the wavelength (to increase the frequency of the wave) and/or necessary to increase the opening of the observation device. Indeed, the spatial resolution R is characterized by the following equation:

$$R = \frac{c * L}{f * O}$$

with c the speed of the light, L the distance between the observation device and the target, f the frequency of the radar and O the opening the observation device.

This is why today it is sought to use radars operating at higher frequency, for example at 77 GHz instead of 24 GHz.

On the contrary, the miniaturization of current radars leads to reducing their opening and therefore their resolution.

Furthermore, a problem encountered for a radar carried by a body part relates to the positioning of the radar. Indeed, it is important to be able to ensure the integrity of a radar, so that it performs its function correctly, even in the event of deformation of the body part bearing it (impact, thermal expansion, etc.). It is therefore necessary to ensure proper positioning of the radar (maintained direction of transmission/reception) throughout the duration of use of the radar function.

It is therefore appropriate to provide a solution making it possible to provide the position and the speed of the objects located around the vehicle and to obtain a more suitable range and spatial resolution, while limiting the cost and energy consumption of the detection device. This makes it possible to improve the detection of objects or persons around the vehicle and to facilitate the implantation of such systems in autonomous vehicles, in particular electric vehicles whose consumption must be limited as much as possible.

To this end, the present disclosure relates to a radar system for a motor vehicle comprising:
an electronic unit configured to transmit and receive an electromagnetic wave in a predetermined frequency range,
a first directional antenna arranged on a first body part of the vehicle and comprising a first reflective cavity reflecting electromagnetic waves wherein a first metasurface is positioned, said first antenna being configured to be connected to the electronic unit via a first waveguide and to transmit an electromagnetic wave, transmitted by the electronic unit and propagated via the first waveguide, in a first predetermined direction and/or to propagate an electromagnetic wave received from the first predetermined direction to the electronic unit via the first waveguide,
a second directional antenna arranged on a second body part comprising a second reflective cavity reflecting electromagnetic waves wherein a second metasurface is positioned, said second antenna being configured to be connected to the electronic unit via a second waveguide and to transmit an electromagnetic wave, transmitted by the electronic unit and propagated via the second waveguide in a second predetermined direction and/or to propagate an electromagnetic wave received from the second predetermined direction to the electronic unit via the second waveguide.

According to other optional features of the radar system, taken either alone or in combination:
The first antenna, called transmitting antenna, is configured to transmit an electromagnetic wave transmitted by the electronic unit and propagated via the first waveguide in the first predetermined direction and the second antenna, called receiving antenna, is configured to receive the electromagnetic wave transmitted by the transmitting antenna and reflected by an obstacle and to propagate the received electromagnetic wave to the electronic unit via the second waveguide.
The first antenna is configured to be arranged behind a plastic wall of the first body part and the second antenna is configured to be arranged behind a plastic wall of the second body part.
The antennas are configured to be arranged facing a uniform plastic wall.
The antennas are configured to be placed facing a plastic wall whose radius of curvature is greater than 500 mm.
The first body part and the second body part are adjacent body parts.
The first body part is arranged on a first side of the vehicle and the second body part is arranged on a second side of the vehicle opposite the first side.
The first and/or second body part is a body part movably mounted on the vehicle.
The predetermined frequency range is greater than 60 GHZ, in particular between 75 and 80 GHZ, in particular 77 GHz. Frequencies between 120 and 160 GHz, in particular 140 GHz, are also possible.
The electronic unit is configured to be positioned at a distance from an external surface of the body parts.

The present disclosure also relates to an assembly comprising at least a first and a second body part, the assembly comprising a radar system as described above.

The present disclosure also relates to a motor vehicle comprising a first body part, a second body part and a radar system as described above.

### BRIEF DESCRIPTION OF THE FIGURES

The present disclosure will be better understood upon reading the following description, which is provided merely as example and with reference to the appended drawings, wherein:

FIG. 1 is a diagram of a radar system according to an embodiment.

FIG. 2 is a perspective view of two antennas of the radar system of FIG. 1 according to an embodiment.

FIG. 3 is a top view of two antennas arranged on two adjacent body parts according to an embodiment.

FIG. 4 is a side view of an antenna arranged on a body part according to an embodiment.

FIG. 5 is a front view of two antennas arranged on a two distinct body parts according to an embodiment.

FIG. 6 is a perspective view of a vehicle comprising a radar device with three antennas distributed across different body parts according to an embodiment.

FIG. 7 is a top view of a vehicle comprising a radar device with three antennas distributed across different body parts according to an embodiment.

### DETAILED DESCRIPTION

In these figures, identical elements bear the same references.

The following embodiments are examples. Although the description refers to one or more embodiments, this does not necessarily mean that each reference relates to the same embodiment, or that the features apply only to a single embodiment. Simple features of different embodiments can also be combined or interchanged to provide other embodiments.

In the present description, it is possible to index certain elements or parameters, such as for example first element or second element as well as first parameter and second parameter or first criterion and second criterion, etc. In this case, it is a simple indexing for differentiating and naming similar but non-identical elements or parameters or criteria. This indexing does not mean that one element, parameter or criterion has priority relative to another, and such designations can easily be changed without departing from the scope of the present description. This indexing does not imply a temporal order, for example, for assessing such a criterion.

Furthermore, in the context of the present disclosure, the orientations are to be understood relative to an XYZ trihedron linked to the vehicle wherein the axis X corresponds to the normal direction of advance of the vehicle, the axis Y corresponds to a transverse axis of the vehicle and the axis Z corresponds to the direction opposite gravity when the vehicle is resting on a flat surface. The plane XY then forms a horizontal plane and the axis Z corresponds to a vertical direction. For any direction D, its azimuth is the angle formed by its projection in the plane XY with the axis X, its elevation is the angle formed by its projection in the plane XZ with the axis X. The axis X corresponds to the value 0° for the azimuth angle (in the plane XY) and the elevation angle (in the plane XZ).

The present disclosure relates to a radar system for a motor vehicle, in particular for an automobile, but the present disclosure can also apply to other types of motor vehicles, in particular land or flying vehicles. FIG. 1 depicts a diagram of a radar system 200 according to one embodiment of the present disclosure. The radar system 200 comprises an electronic unit 900 comprising a primary transmitter 931 configured to transmit an electromagnetic wave in a predetermined frequency range and a primary receiver 932 configured to receive an electromagnetic wave in the predetermined frequency range. The frequency range corresponds to values greater than 60 GHz, in particular between 75 and 80 GHz, for example 77 GHz, which is the standardized value of automotive radar devices. Frequencies between 120 and 160 GHZ, in particular 140 GHz, are also possible. The electronic unit 900 also comprises control electronics 940 configured to control the transmitter 931 and the receiver 932.

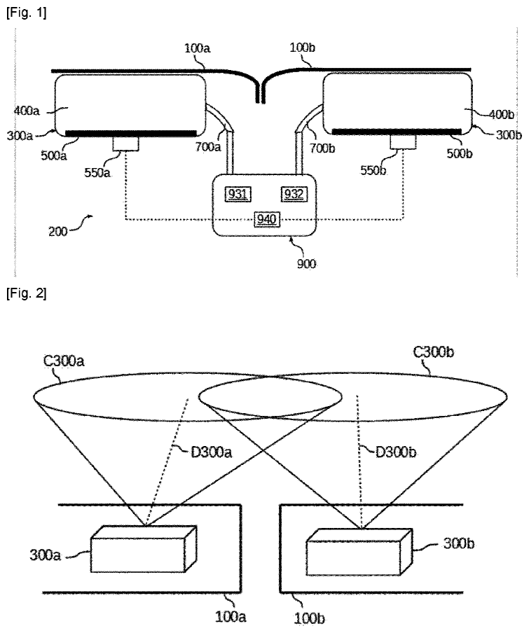

The radar system 200 also comprises a first directional antenna 300a arranged behind a first body part 100a and comprising a first reflective cavity 400a reflecting electromagnetic waves, wherein a first metasurface 500a is positioned. The reflective cavity 400a corresponds to a volume configured to reflect electromagnetic waves at the limits of the volume. The reflective surfaces are for example embodied by metal surfaces. The reflective cavity 400a also comprises non-reflective portions to allow the transmission and/or reception of an electromagnetic wave in a predetermined direction. The predetermined direction corresponds to a transmission and/or reception cone C300a around a first central axis D300a as shown in FIG. 2. The first central axis D300a extends for example in a direction perpendicular to the plane formed by the metasurface and/or by an output face of the first directional antenna 300a (the first directional antenna 300a has a parallelepiped shape and the output face corresponds to one of the faces of the parallelepiped). The shape of the transmission and/or reception cone C300a depends in particular on the shape of the metasurface 500a. With a metasurface 500a of elongated shape, for example rectangular, the transmission and/or reception cone C300a for example also has an elongated section, for example elliptical or oblong, the large axis of which corresponds to the longitudinal axis of the metasurface 500a. A control electronics item 550a is for example associated with the metasurface 500a and connected to the electronic unit 900. This control electronics item 550a makes it possible, for example, to integrate the shift register necessary for controlling the controlled surface of the metasurface 500a, or according to another example, for specializing the directional antenna 300a.

The first antenna 300a is connected to the electronic unit 900 via a first waveguide 700a. The first waveguide 700a makes it possible to propagate an electromagnetic wave transmitted by the transmitter 931 of the electronic unit 900 toward the first antenna 300a and/or to propagate an electromagnetic wave received by the first antenna 300a to the receiver 932 of the electronic unit 900.

The radar system 200 also comprises a second directional antenna 300b arranged behind a second body part 100b with a second predetermined direction corresponding to a second transmission and/or reception cone C300b around a second central axis D300b (see FIG. 2). The second antenna 300b comprises a second cavity 400b reflecting the electromagnetic waves wherein a second metasurface 500b is positioned.

A control electronics item 550b is for example associated with the metasurface 500b and connected to the electronic unit 900. This control electronics item 550b makes it possible, for example, to integrate the shift register necessary for controlling the controlled surface of the metasurface 500b, or according to another example, for specializing the directional antenna 300b.

The constituent elements of the second antenna 300b may be similar to the constituent elements of the first antenna 300a. The two antennas 300a and 300b can be identical, which makes it possible to standardize the production and thus reduce costs.

However, the second antenna 300b may also have different dimensions from the first antenna 300a. In addition, the orientations of the first 300a and the second 300b antennas may be different so that the first and the second predetermined direction may be different.

The second antenna 300b is connected to the electronic unit 900 via a second waveguide 700b. The second waveguide 700b makes it possible to propagate an electromagnetic wave transmitted by the transmitter 931 of the electronic unit 900 to the second antenna 300b and/or to propagate an electromagnetic wave received by the second antenna 300b to the receiver 932 of the electronic unit 900.

As shown in FIG. 2, the antennas 300a and 300b can have an elongated shape corresponding to the shape of the metasurface 500a, 500b and the transmission and/or receiving cone C300a, C300b associated with the antenna for example has an oblong section whose major axis corresponds to the longitudinal axis of the antenna 300a, 300b and is proportional to the large dimension of the metasurface 500a, 500b. The transmission and/or reception angle is for example between 80 and 110°, in particular 90° (+/−45° relative to the central axis D300a, D300b) along the large axis of the oblong shape and 20° (+/−10° relative to the central axis D300a, D300b) along the small axis of the oblong shape.

The arrangement of the two antennas 300a, 300b on two different body parts 100a, 100b makes it possible to increase the detection field by placing the antennas 300a, 300b on body parts 100a, 100b having different shapes and curvatures, which allows the antennas to be placed, and above all oriented, in a more favorable way. In addition, this makes it possible to multiply the possible locations for the antennas 300a, 300b and thus to more easily find an available location for the antennas 300a, 300b taking into account all the constraints (available space, desired orientation, interactions with other equipment, location and length of waveguides, etc.).

The first 100a and the second 100b body parts can be adjacent body parts, which makes it possible to reduce the distance between the antennas 300a, 300b and thus to limit the length of the waveguides 700a, 700b. A reduced length of the waveguides 700a, 700b makes it possible to limit the losses or attenuation during the propagation of the electromagnetic wave in the waveguides 700a, 700b.

The first 100a and the second 100b body parts can also be distant body parts and/or body parts having different orientations, for example on both sides of the vehicle 1 or on an upper part and a lower part of the vehicle 1, which makes it possible to widen the detection field and to combine detection information coming from opposite directions within the same radar system 200.

At least one of the antennas 300a, 300b can be mounted on a body part mounted movably relative to the vehicle such as a door, a trunk door or a tailgate. The mobility of the body part can be used for additional detections during the movement of this or these part(s).

In the case where the first antenna 300a is the transmitting antenna and the second antenna 300b is the receiving antenna, in order to maximize the detection range, the angular difference between the first central axis D300a and the second central axis D300b (measured in the plane defined by the directions D300a and D300b) is preferably chosen less than or equal to 30°.

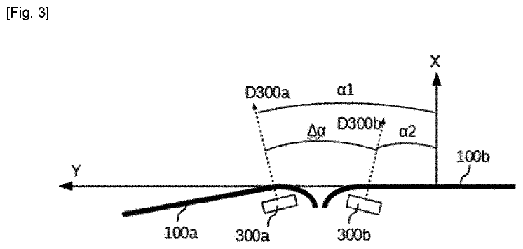

In the case of implantation in a motor vehicle 1 such as an automobile and in particular on a front body part 100a, 100b such as a front bumper or a grille as shown in projection in the top view of FIG. 3, the angular deviation Δa between the azimuth angle α1 of the first central axis D300a and the azimuth angle α2 of the second central axis D300b is preferably less than or equal to 30°, for example equal to 30° so as to optimize the detection.

For a lateral detection for which the range is less significant, a difference in azimuth angle Aa between the first central axis D300a and the second central axis D300b greater than 30°, for example 40°, can be used.

In order to limit the non-relevant detections, for example the detection of a bridge or a walkway in the case of an automobile, as shown in projection in FIG. 4, the elevation angle βbetween the first or second central axis D300a, D300b and the horizontal direction (plane XY) is less than 10° (+/−5° relative to the horizontal direction), preferably less than 5° (+/−2.5° relative to the horizontal direction.

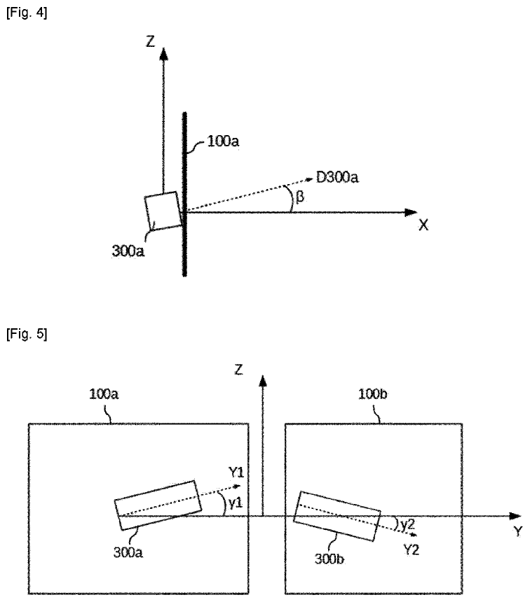

Furthermore, still to limit the non-relevant detections, as shown in the front projection view of FIG. 5, the pitch angle γ1 or γ2 between the longitudinal direction of the antenna Y1 or Y2 (corresponding to the large axis of the section of the transmission or receiving cone associated with the antenna) with the horizontal direction is preferably less than 30°, in particular less than 5°. The pitch angles of the antennas 300a, 300b will be chosen substantially equal to maximize the detection range.

The antennas 300a, 300b are preferably placed behind a uniform area of the body part 100a, 100b, that is, having a uniform composition and a constant thickness, so as to limit the parasitic reflections of the electromagnetic wave. For this reason, if possible, placing the antenna between two body parts 100a, 100b will be avoided.

The first antenna 300a can be a transmitting antenna used only for transmitting an electromagnetic wave and the second antenna 300b may be a receiving antenna used only for receiving an electromagnetic wave. In this case, the transmission and the reception can be continuous, which makes it possible to obtain continuous detection. The receiving antenna 300b is then configured to detect the electromagnetic wave transmitted by the transmitting antenna 300a and reflected by an obstacle located in the transmission cone C300a of the transmitting antenna 300a toward the receiving cone C300b of the receiving antenna 300b.

In this case, the difference in pitch angle between the longitudinal direction Y1 of the first antenna 300a and the longitudinal direction Y2 of the second antenna 300b is preferably less than 30°, in particular less than 10°, for example 0°, so as to limit the losses between the transmission and the reception and thus to maximize the detection range.

The antennas 300a, 300b and in particular the metasurfaces 500a, 500b are preferably placed as close as possible to the inner surface of the body part 100 in order to limit potential interfering reflections.

Using a first 300a and a second 300b antenna of the same radar system 200 having different orientations also makes it possible to increase the detection field relative to the use of a single antenna.

Furthermore, the configuration of the radar system 200 makes it possible to position the antennas 300a, 300b as close as possible to the inner surfaces of the body parts 100a, 100b so as to limit the losses or the risk of reflection on the body part 100a, 100b while the electronic unit 900 can be arranged further back relative to the body part 100a, 100b so as to protect it from any impact on the body part(s) 100a, 100b. Arranging the antennas 300a, 300b, 300b′ on two separate body parts 100a and 100b also makes it possible, in the event of damage to one of the body parts, for example part 100a, to continue to use the antenna 300b arranged on the other body part 300b to continue detection. The antenna 300b can then be used for transmission and reception in a degraded detection mode. In addition, it is then only necessary to change one of the body parts 100a, 100b and therefore one antenna 300a instead of having to change the entire radar system 200, which reduces the cost of repairs.

The distance between the electronic unit 900 and the antennas 300a, 300b can be for example less than 500 mm so as to limit the losses or attenuations during the propagation of the electromagnetic wave in the waveguides 700a, 700b. To this end, the two body parts 100a and 100b can be chosen to be adjacent.

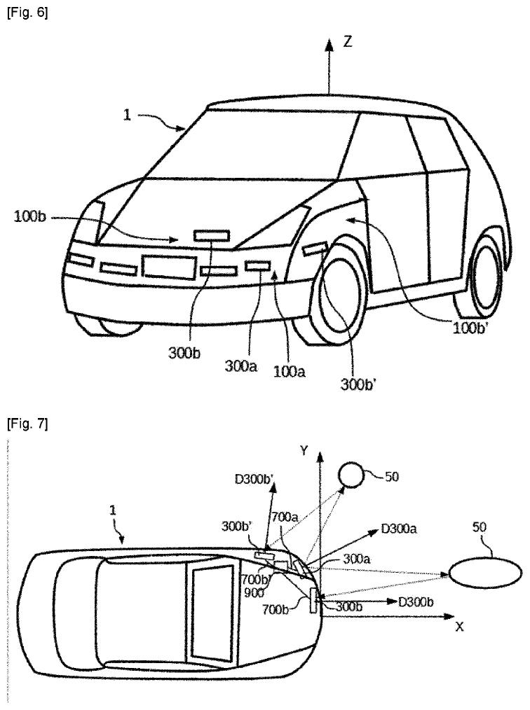

According to a particular embodiment shown in FIGS. 6 and 7, the radar system 200 comprises a transmitting antenna 300a arranged on a first body part 100a, here the skin of the front bumper, a first receiving antenna 300b arranged on a second body part 100b, here the faceplate of the front bumper, and a second receiving antenna 300b′ arranged on a third body part 100b′, here the left front wing of a motor vehicle 1. The antennas 300a, 300b, 300b′ are for example attached to the rear of the parts forming the front face of the vehicle 1, respectively the bumper skin 100a, the bumper faceplate 100b and the wing 100b′. The electronic unit 900 is for example arranged further back from the body parts 100a, 100b and 100b′ so as to be protected in the event of an impact. The antennas 300a, 300b and 300b′ are arranged in different areas of the vehicle 1, the different areas being offset from one another along the width of the vehicle 1, that is, along the axis Y, and the transmitting antenna 300a is arranged in a central area relative to the areas associated with the receiving antennas 300b and 300b which makes it possible to obtain an important detection field for the radar system 200.

Concerning the height position of the antennas 300a, 300b and 300b′ at the body parts 100a, 100b, and 100b′, in particular for the antennas arranged on the front part of the vehicle 1 such as the antennas 300a and 300b, they are preferably positioned above a horizontal plane passing through the highest point of the impact beam and its absorber or below a horizontal plane passing through the lowest point of the impact beam and its absorber.

The central axis D300b of the receiving cone of the first receiving antenna 300b is oriented in azimuth in a direction corresponding substantially to the direction X of advance of the vehicle 1; the angular deviation in azimuth is for example less than 5°, in particular equal to 0° so as to be able to carry out a frontal detection of the obstacles 50 located in front of the vehicle 1 as shown in FIG. 7. The elevation angle of the central axis D300b is substantially coincident with the horizontal direction; the angular deviation between the central axis D300b and the horizontal direction (plane XY) is in particular less than 5°. The transmitting antenna 300a can have substantially the same orientation as the first receiving antenna 300b or can be angularly offset in azimuth from the side of the second receiving antenna 300b′. The deviation in azimuth angle between the central axis D300a of the transmission cone of the transmitting antenna 300a and the central axis D300b of the receiving cone of the first receiving antenna 300b is for example less than 30°, for example 20° so as to maximize the detection range in the frontal direction of the vehicle 1. The elevation angle of the central axis D300a of the transmission cone of the transmitting antenna 300a is substantially coincident with the horizontal direction, the angle between the central axis D300a and the horizontal direction is in particular less than 5°, for example equal to 0°. The second receiving antenna 300b′ has an azimuthal orientation different from the first receiving antenna 300b to widen the detection field and allow detection of obstacles 50 located on the side of the vehicle 1. The deviation in azimuth angle between the central axis D300a of the transmission cone of the transmitting antenna 300a and the central axis of the receiving cone D300b′ of the first receiving antenna 300b is for example greater than 30°, for example 40°. The elevation angle of the central axis D300b′ of the receiving cone of the second receiving antenna 300b′ is substantially coincident with the horizontal direction, in particular less than 5°, for example equal to 0°.

In the example of FIGS. 6 and 7, the first receiving antenna 300b has a length greater than the transmitting antenna 300a and the second receiving antenna 300b′ (the latter two antennas being able to have the same length). A greater antenna length corresponds to a metasurface 500a, 500b of larger dimension making it possible to obtain a larger opening and therefore an improved spatial resolution making it possible to discriminate two distinct elements located at a significant distance, for example 100 m. The first receiving antenna 300b of greater dimension thus makes it possible to increase the spatial resolution in the frontal direction corresponding to the direction X of forward movement of the vehicle 1. The receiving cone of the second receiving antenna 300b′ may comprise an overlap area with the receiving cone of the first receiving antenna 300b. Such an overlap may in particular make it possible to detect a malfunction of one of the receiving antennas 300b, 300b′.

In addition, such an overlap makes it possible to track an obstacle moving in the detection field covered by the entire radar system 200 comprising the transmitting antenna 300a and the two receiving antennas 300b and 300b′. This tracking is possible in particular due to a common electronic unit 900 to which the various antennas 300a, 300b, 300b′ are connected. Using a common electronic unit also makes it possible to limit the latencies linked to the detection of obstacles, particularly when tracking an obstacle moving in the detection field covered by the various antennas 300a, 300b, 300b′.

Thus, in operation, the transmitting antenna 300a transmits an electromagnetic wave in its transmission cone. This electromagnetic wave is reflected by obstacles 50, such as other vehicles or pedestrians or fixed urban elements, and returned to the receiving cone of the first receiving antenna 300b for obstacles 50 located in front of the vehicle 1 and toward the receiving cone of the second receiving antenna 300b′ for the obstacles 50 located on the left side of the vehicle 1 as shown by the dotted arrows in FIG. 7.

Furthermore, the antennas 300a, 300b, 300b′ can be reconfigured so that a transmitting antenna 300a can be reconfigured to allow reception of the electromagnetic wave and, conversely, a receiving antenna 300b, 300b′ can be reconfigured to transmit an electromagnetic wave. Thus, for example, in the event of a malfunction of the transmitting antenna 300a, the first receiving antenna 300b can be reconfigured into a transmitting antenna in order to make it possible to preserve a detection function in association with the second receiving antenna 300b′. However, the detection is then degraded; the range and/or the detection field are for example reduced relative to the initial configuration.

The radar system 200 may also comprise a larger number of receiving antennas, for example to allow detection on the right-hand side of the vehicle 1. The radar system 200 may also comprise several transmitting antennas. The antennas 300a, 300b, 300b′ shown in FIGS. 6 and 7 only on the left side of the vehicle can be duplicated, preferably symmetrically, on the right side of the vehicle and the six antennas (two transmitting antennas and four receiving antennas) can be connected to a common electronic unit 900 thus allowing a detection field covering an angular area of at least 180°, or even 200° around the front bumper. In addition, the radar system 200 may comprise a plurality of electronic units 900 and the antennas 300a, 300b, 300b′ can be connected to different electronic units 900. In the various embodiments described, the electronic unit 900 comprises a single transmitter 931 and a single receiver 932.

Alternatively, the antennas 300a and 300b can be used for transmission and reception. In this case, transmission and reception are done alternately for each of the antennas. In this case, the orientation of the antennas is chosen based on the desired detection field. In addition, one antenna can be used in transmit and receive mode in the event of failure of another antenna to preserve the detection capacity of the radar system 200.

The present disclosure also relates to an assembly comprising at least a first body part 100a and a second body part 100b and a radar system 200 as described above.

The present disclosure also relates to a motor vehicle 1, in particular an automobile, comprising a first body part 100a, a second body part 100b and a radar system 200 as described above. The body parts 100a, 100b comprise a plastic wall behind and whereupon one or more antennas 300a, 300b are positioned and attached. Preferably, the plastic wall is homogeneous so as not to disrupt the transmission of the electromagnetic wave. The term “homogeneous” is understood here to mean that the thickness is substantially constant, that the same material or the same layers of materials are used and that the wall is solid (without openings as for an air intake grid). Also preferably, the curvature of the plastic wall facing the antenna 300a, 300b is reduced; the radius of curvature is for example greater than 500 mm so as to limit the spaces that can appear between the antenna, which can be flat, and the curved body part. The body parts 100a, 100b can be made up of several plastic components and comprise several antennas; the antennas can be distributed over the various components of the different body parts.

The electronic unit 900 can also be attached to the body part 100a, 100b, but not necessarily against the plastic wall.

The body parts 100a, 100b may be selected from a front bumper, a rear bumper, a wing, a side door, a tailgate, a middle/front/rear foot, a side arch, a front/rear roof cross-member, or any other body part comprising a wall made from plastic material allowing propagation of the electromagnetic wave transmitted by the radar system 200.

The vehicle 1 can also comprise different radar systems 200 whose antennas 300a, 300b, 300b′ are distributed on different body parts 100a, 100b, 100b′ of the vehicle 1 to allow detection of obstacles 50 around the entire vehicle 1.

What is claimed is:

1. A radar system for a motor vehicle comprising:
an electronic unit configured to transmit and receive an electromagnetic wave in a predetermined frequency range;
a first directional antenna arranged on a first body part of the motor vehicle and comprising a first reflective cavity reflecting electromagnetic waves wherein a first metasurface is positioned, wherein said first directional antenna is configured to be connected to the electronic unit via a first waveguide, and wherein the first directional antenna is configured to transmit the electromagnetic wave, transmitted by the electronic unit and propagated via the first waveguide in a first predetermined direction and/or to propagate the electromagnetic wave received from the first predetermined direction to the electronic unit via the first waveguide; and
a second directional antenna arranged on a second body part that has a second cavity reflecting the electromagnetic waves wherein a second metasurface is positioned, wherein said second directional antenna is configured for connection to the electronic unit via a second waveguide and for transmitting the electromagnetic wave transmitted by the electronic unit and propagated via the second waveguide in a second predetermined direction and/or for propagating the received electromagnetic wave from the second predetermined direction to the electronic unit via the second waveguide.

2. The radar system according to claim 1, wherein the first directional antenna is a transmitting antenna and is configured to transmit the electromagnetic wave transmitted by the electronic unit and propagated via the first waveguide in the first predetermined direction and the second directional antenna is a receiving antenna and is configured to receive the electromagnetic wave transmitted by the transmitting antenna and reflected by an obstacle and to propagate the received electromagnetic wave to the electronic unit via the second waveguide

3. The radar system according to claim 1, wherein the first directional antenna is configured to be arranged behind a plastic wall of the first body part and the second directional antenna is configured to be arranged behind a plastic wall of the second body part.

4. The radar system according to claim 3, wherein the first directional antenna and the second directional antenna are configured to be arranged facing a uniform wall of a plastic material.

5. The radar system according to claim 3, wherein the first directional antenna and the second directional antenna are configured to be placed facing the plastic wall whose radius of curvature is greater than 500 mm.

6. The radar system according to claim 1, wherein the first body part and the second body part are adjacent body parts.

7. The radar system according to claim 1, wherein the first body part is arranged on a first side of the vehicle and the second body part is arranged on a second side of the vehicle opposite to the first side of the vehicle.

8. The radar system according to claim 1, wherein at least one of: the first body part and the second body part is a body part movably mounted on the motor vehicle.

9. The radar system according to claim 1, wherein the predetermined frequency range is greater than 60 GHz.

10. The radar system according to claim 1 wherein the electronic unit is configured to be positioned remotely from the first body part and the second body part.

11. An assembly, comprising at least a first body part and a second body part, wherein the assembly further comprises a radar system, wherein the radar system further comprises:
an electronic unit configured to transmit and receive an electromagnetic wave in a predetermined frequency range;
a first directional antenna arranged on a first body part of the motor vehicle and comprising a first reflective cavity reflecting electromagnetic waves wherein a first metasurface is positioned, wherein said first directional antenna is configured to be connected to the electronic unit via a first waveguide, and wherein the first directional antenna is configured to transmit the electromagnetic wave, transmitted by the electronic unit and propagated via the first waveguide in a first predetermined direction and/or to propagate the electromagnetic wave received from the first predetermined direction to the electronic unit via the first waveguide; and
a second directional antenna arranged on a second body part that has a second cavity reflecting the electromagnetic waves wherein a second metasurface is positioned, wherein said second directional antenna is configured for connection to the electronic unit via a second waveguide and for transmitting the electromagnetic wave transmitted by the electronic unit and propagated via the second waveguide in a second predetermined direction and/or for propagating the received electromagnetic wave from the second predetermined direction to the electronic unit via the second waveguide.

12. A motor vehicle, comprising a first body part, a second body part, and a radar system, wherein the radar system further comprises:
an electronic unit configured to transmit and receive an electromagnetic wave in a predetermined frequency range;
a first directional antenna arranged on a first body part of the motor vehicle and comprising a first reflective cavity reflecting electromagnetic waves wherein a first metasurface is positioned, wherein said first directional antenna is configured to be connected to the electronic unit via a first waveguide, and wherein the first directional antenna is configured to transmit the electromagnetic wave, transmitted by the electronic unit and propagated via the first waveguide in a first predetermined direction and/or to propagate the electromagnetic wave received from the first predetermined direction to the electronic unit via the first waveguide; and
a second directional antenna arranged on a second body part that has a second cavity reflecting the electromagnetic waves wherein a second metasurface is positioned, wherein said second directional antenna is configured for connection to the electronic unit via a second waveguide and for transmitting the electromagnetic wave transmitted by the electronic unit and propagated via the second waveguide in a second predetermined direction and/or for propagating the received electromagnetic wave from the second predetermined direction to the electronic unit via the second waveguide.

13. The radar system according to claim 1, wherein the predetermined frequency range is between 75 and 80 GHz.

14. The radar system according to claim 1, wherein the predetermined frequency range is 77 GHz.
